(19) United States
(12) Patent Application Publication
(10) Pub. No.: US 2009/0304169 A1
(43) Pub. Date: Dec. 10, 2009

(54) ADVERTISEMENT OR INFORMATION FEEDING METHOD, SYSTEM, AND PROGRAM FOR COMPLETING DEALS BETWEEN POTENTIAL CONSUMERS AND INFORMATION PROVIDERS

(75) Inventor: Ching-Kay Chow, San Jose, CA (US)

Correspondence Address: Ching-Kay Chow, 3100 Magnum Drive, San Jose, CA, 95135, US

(73) Assignee: GV CONCEPTS INC., San Jose, CA (US)

(21) Appl. No.: 12/372,723

(22) Filed: Feb. 17, 2009

Related U.S. Application Data
(60) Provisional application No. 61/059,207, filed on Jun. 5, 2008.

(51) Int. Cl. H04M 3/42

(52) U.S. Cl. 379/201.01

(57) ABSTRACT

A method for pushing information to and receiving information from a voice terminal over a communication network includes a client storing at least one piece of personal information in the voice terminal. The client enables an advertisement feature of the voice terminal. The voice terminal communicates with an information server and transmits the piece of personal information. The voice terminal receives from the information server an information item wherein content of the information item at least in part matches the piece of personal information. If the client desires additional information, the client activates a first feature of the voice terminal wherein the voice terminal connects to an information voice terminal. If the client chooses to respond to a request contained in the information item, the client activates a second feature of the voice terminal wherein the voice terminal connects to a system for transmission of a response from the client.

### CROSS-REFERENCE TO RELATED APPLICATIONS

The present Utility patent application claims priority benefit of the U.S. provisional application for patent Ser. No. 61/059,207 on Jun. 5, 2008 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the field of feeding information, advertising and dealing through a communications network. More particularly, the invention relates to a method for pushing advertisement or information on the Internet or a mobile network, and a voice terminal for receiving advertisements and information and aiding a user in completing a transaction and a task.

### BACKGROUND OF THE INVENTION

Merchants carry out advertisements for the promotion of the sale of goods and services and the enhancement of public relations. Currently, the online advertisement market is growing rapidly. However, online advertisements are typically blind-push from Internet browsers. Only when a potential customer sits before a computer is the potential customer in contact with the advertisement. Currently, no other online devices can selectively get appropriate advertisements or information to potential customers and enhance transaction or information exchange by having phone conversation.

In a typical example of current online advertisement methods, if a customer sees an interesting advertisement in an Internet browser, he may click on the advertisement to learn more information, use a phone to call the merchant directly, or visit the merchant in person. If the customer wishes to make a deal, he must contact the merchant or use an online payment system to complete the deal. Normally, customers go to a website to order a product from the merchant, and the customer must make a call with a public switched telephone network (PSTN) in order to ask any questions. The process is complex, and the customer must perform many of these tasks in front of a computer. Furthermore, using current methods, service providers or web servers typically push any advertisement to any customer, not specified target group customers. In other typical example of current information feeding methods, if a customer sees an interesting cooking recipe from a device, he may click and see the way how it cooks. But if a customer has a question or have some suggestion, there is no way a customer can contact with the information provider.

In view of the foregoing, there is a need for improved techniques for providing advertisements or information on devices that are connected to the Internet or a mobile network that aid users in completing deals or requests and are matched to potential customers.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram illustrating an exemplary system structure providing a method for advertising and enhancing a potential customer to purchase merchandise from a merchant, in accordance with an embodiment of the present invention;

FIG. 2 illustrates a block diagram of an exemplary system enabling a merchant to submit an advertisement or information to an advertisement or information server, in accordance with an embodiment of the present invention;

FIG. 3 is a flow chart illustrating an exemplary process for push advertisement to a voice terminal, in accordance with an embodiment of the present invention;

FIG. 4 is a flow chart illustrating an exemplary process for a potential customer to interact with a customer voice terminal to make a transaction with a merchant using “push-to-call” and “buy-it-now” options, in accordance with an embodiment of the present invention;

FIG. 5 is a block diagram illustrating an exemplary system enabling a merchant to manage multiple potential customers by setting up multiple merchant voice terminals, in accordance with an embodiment of the present invention; and

FIG. 6 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, an advertisement and information feeding method, system, and program for completing deals between potential consumers and information providers is presented.

In one embodiment, a method for pushing information to and receiving information from a voice terminal over a communication network is presented. The method includes the steps of a client in possession of the voice terminal storing at least one piece of personal information in the voice terminal. The client enabling an advertisement feature of the voice terminal. The voice terminal communicating with an information server in response to the enabling and transmitting to the information server the at least one piece of personal information. The voice terminal receiving from the information server an information item provided by an information provider wherein content of the information item at least in part matches the at least one piece of personal information. The client viewing the information item. If the client desires additional information on the information item, the client activating a first feature of the voice terminal wherein the voice terminal connects to an information provider voice terminal such that the client can request and receive the additional information from the information provider. If the client chooses to respond to a request contained in the information item, the client activating a second feature of the voice terminal wherein the voice terminal connects to a system of the information provider for transmission of a response from the client to the information provider. In another embodiment the voice terminal connects to the information provider through a call management server. In yet another embodiment the voice terminal communicates with the information server periodically when the advertisement feature is enabled. In a further embodiment when the voice terminal connects to the information provider, the voice terminal transmits at least one identifying item identifying the information item. In still another embodiment the information provider is a merchant, the information item is an advertisement for a product and the client is a potential customer. In another embodiment when the voice terminal receives the advertisement, the voice terminal further receives a merchant ID for identifying the merchant, an advertisement/information ID for identifying the product during communication from the information server and a communication ID with product information used to establish the communication from the customer to the merchant. In yet another embodiment the response from the potential customer is a request to buy the product. In still another embodiment when the potential customer completes a transaction with the merchant, the potential customer receives a transaction ID from the call management server.

In another embodiment a system for an information provider to push an information item to a client and receive information from the client over a communication network is presented. The system includes a voice terminal in possession of the client. At least one piece of personal information about the client is stored in the voice terminal. An advertisement feature of the voice terminal selectively enabled by the client is included. An information server in communication with the voice terminal is included wherein in response to the advertisement feature being enabled the voice terminal transmits to the information server the at least one piece of personal information and the information server transmits the information item to the voice terminal when content of the information item at least in part matches the at least one piece of personal information. A first feature of the voice terminal selectable by the client when the client desires additional information on the information item is included. An information provider voice terminal of the information provider in communication with the voice terminal when the client activates the first feature is included wherein the client can communicate with the information provider. A second feature of the voice terminal selectable by the client when the client desires to respond to a request contained within the information item is included. A computing system of the information provider in communication with the voice terminal when the client activates the second feature is included wherein the voice terminal transmits a response from the client to the information provider. Another embodiment further includes a call management server connecting the voice terminal to the information provider. In another embodiment when the advertisement feature is enabled, the voice terminal periodically communicates with the information server. Another embodiment further includes at least one identifying item identifying the information item wherein when the voice terminal connects to the information provider, the voice terminal transmits the at least one identifying item. In still another embodiment the information provider is a merchant, the information item is an advertisement for a product, the client is a potential customer and the system further includes a merchant ID for identifying the merchant, the at least one identifying item is an advertisement/information ID for identifying the product during communication from the information server and a communication ID with product information used to establish the communication from the customer to the merchant. In yet another embodiment the response from the potential customer is a request to buy the product. Still another embodiment further includes a transaction ID transmitted from the call management server to the potential customer and the merchant when the potential customer completes a transaction with the merchant.

In another embodiment a computer program product for pushing information to and receiving information from a voice terminal over a communication network is presented. The computer program product includes computer code for a client in possession of the voice terminal storing at least one piece of personal information in the voice terminal. Computer code for the client enabling an advertisement feature of the voice terminal is included. Computer code for the voice terminal periodically communicating with an information server in response to the enabling and transmitting to the information server the at least one piece of personal information is included. Computer code for the voice terminal receiving from the information server an information item provided by an information provider is included wherein content of the information item at least in part matches the at least one piece of personal information. Computer code for the client viewing the information item is included. Computer code for if the client desires additional information on the information item, the client activating a first feature of the voice terminal is included wherein the voice terminal connects to an information provider voice terminal such that the client can request and receive the additional information from the information provider. Computer code for if the client chooses to respond to a request contained in the information item, the client activating a second feature of the voice terminal is included wherein the voice terminal connects to a system of the information provider for transmission of a response from the client to the information provider. A computer readable medium for storing the computer code is included. In another embodiment the voice terminal connects to the information provider through a call management server. In still another embodiment the information provider is a merchant, the information item is an advertisement for a product, the client is a potential customer and when the voice terminal receives the advertisement, the voice terminal further receives a merchant ID for identifying the merchant, an advertisement/information ID for identifying the product during communication from the information server and a communication ID with product information used to establish the communication from the customer to the merchant. In further embodiment the response from the potential customer is a request to buy the product. In still another embodiment when the potential customer completes a transaction with the merchant, the potential customer receives a transaction ID from the call management server.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Preferred embodiments of the present invention provide an advertisement method for online devices that enables convenient communication and dealing between a customer and a merchant. Preferred embodiments enable a merchant to advertise through a service provider to potential customers who are not using personal computers. The preferred embodiment comprises an advertisement server, a call management server, a merchant voice terminal, and a customer voice terminal. The advertisement method in the preferred embodiment provides an advertisement push method based on factors concerning the customer such as, but not limited to, the local time, location, customer preferences, target group, etc. to determine which advertisements are pushed to which terminals. Preferred embodiments of the present invention combine voice, pictures and/or text messages to facilitate the interaction between a merchant and a potential customer and enhance the experience of the customer.

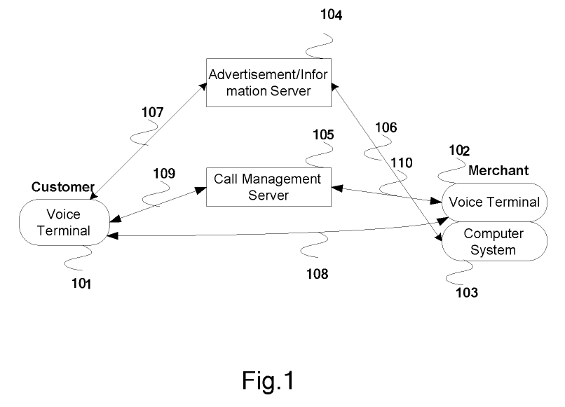

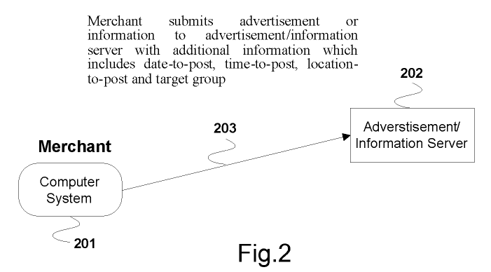

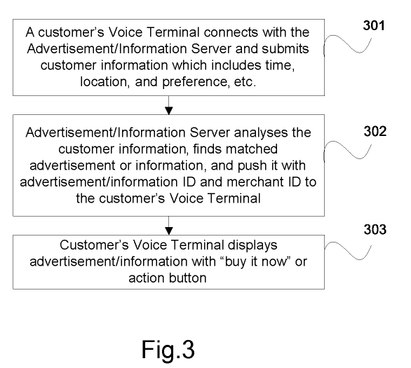

FIG. 1 is a block diagram illustrating an exemplary system structure providing a method for advertising and enabling a potential customer to purchase merchandise from a merchant, in accordance with an embodiment of the present invention. In the present embodiment a customer with a customer voice terminal 101 logs into a communication network. In alternate embodiments, different types of networks may be used to connect the system components, for example, without limitation, the Internet or wireless networks. Those skilled in the art, in light of the present teachings, will readily recognize that a multiplicity of devices may suitably act as customer voice terminal 101 including, without limitation, mobile phones, personal digital assistants (PDAs), pocket PCs, computers, etc. In the present embodiment, customer voice terminal 101 communicates with a call management server 105 through a connection 109. If an advertisement/information option is enabled on customer voice terminal 101, customer voice terminal 101 communicates with an information sever 104 through a connection 107 and sends information such as, but not limited to, local time, location and some personal information about the customer, for example, without limitation, age, sex or occupation, if this information is available. A non-limiting example of the communication between a customer voice terminal and an information server is illustrated in FIG. 3. Customer voice terminal 101 may also communicate directly with a merchant voice terminal 102 through a connection 108. This enables the customer to deal directly with the merchant. Those skilled in the art, in light of the present teachings, will readily recognize that a multiplicity of devices may suitably act as merchant voice terminal 102 including, without limitation, mobile phones, conventional telephones, PDAs, computers, etc. In the present embodiment, merchant voice terminal 102 may also communicate with call management server 105 through a connection 110. In the present embodiment, merchant voice terminal 102 is connected to a computer system 103, and computer system 103 communicates with advertisement server 104 through a connection 106. The communication of a merchant computer system with an advertisement server is shown by way of example in FIG. 2. In alternate embodiments, the merchant voice terminal and the computer system may be integrated into one device depending on the type of merchant voice terminal being used. For example, without limitation, if the merchant is using a PDA with mobile phone capabilities, the merchant is able to perform the functions of the computer system and the voice terminal with this single device.

In typical use of the present embodiment, the merchant first supplies an advertisement or information to Advertisement or Information Server 104. The advertisement may include information, such as, but not limited to, text, pictures, video, the merchant's call ID, the advertisement/information ID, keywords for matching, post time, post location, etc. In some embodiments the merchant may use an interactive method to provide additional information to the potential customer for example, without limitation, teaching, cooking, etc. In the present embodiment, when customer voice terminal 101 is online and the advertisement feature is enabled, customer voice terminal 101 connects with advertisement/information server 104 and submits the current customer's information, including, without limitation, current time, location, personal settings such as, but not limited to, sex, age, and products or services that may be of interest to the customer, etc. Advertisement/information server 104 then attempts to find an advertisement/information that matches this customer's information. If a matched advertisement or information is found, advertisement/information server 104 sends the advertisement/information along with the merchant call ID, advertisement ID and the product information. Customer voice terminal 101 then displays the advertisement/information on a screen along with options such as, but not limited to, an option to call the merchant or to buy the product. Herein the option to call the merchant will be described as the “push-to-call” option or button, and the option to purchase the product will be described as the “buy-it-now” option or button. However, those skilled in the art, in light of the present teachings, will readily recognize that these options may be represented by a multiplicity of suitable representations on the customer voice terminal in various alternate embodiments including, but not limited, a “push-to-connect” button, a “push-to-talk” button, a “push-to-buy” button, a “push-to-order” button, an option menu, etc.

If the customer is interested in the advertisement and would like to know more information, the customer may select the “push-to-call” option on the advertisement on the screen of customer voice terminal 101 to communicate with the merchant directly. Using this function, the customer does not need to know the phone number of the merchant in order to contact the merchant. If the customer selects the “push-to-call” option or picks up a handset on customer voice terminal 101, customer voice terminal 101 automatically sends the advertisement ID to merchant computer system 103 and customer voice terminal 101 places a call through call management server 105 to merchant voice terminal 102. In the present embodiment, the customer has the option to hide his call ID from the merchant.

When the customer uses voice terminal 101, the customer may select to use a voice-to-order function with payment information, or the merchant may send additional information or a request for payment information and the customer may directly submit payment information with a security password. For example, without limitation, the customer is interested in the product, but he/she has few questions regarding the product. He/she may make a call by push “voice-to-order” from the voice terminal. He/She may request additional information to the merchant by voice. After clearing questions from the merchant, the merchant may request for payment information and the customer may directly submit payment information with a security password. When the customer sees the advertisement and wants to make a deal without talking with merchant, the customer may select the “buy-it-now” function on the advertisement. Voice terminal 101 then sends the advertisement ID and the merchant ID to merchant computer system 103, and merchant computer system 103 sends a request for payment information, and the customer may directly submit payment information to the merchant with a security password.

The following is a non-limiting example of the utilization of the present embodiment. Tom stores credit card information in his mobile phone with a security password. Tom views an advertisement for a watch that he would like to buy on his mobile phone. Tom selects the “buy-it-now” function on the advertisement and enters the security password for sending payment information. If Tom selects the “push-to-call” function, he will directly talk to the merchant and clarify all of his needs before completing the transaction. The present embodiment helps the customer and the merchant to deal directly and easily.

In another non-limiting example, Valentine's Day is approaching, and a local flower shop in San Jose would like to run a Valentine's Day advertisement to the San Jose area. Accordingly, the owner of the local flower shop submits an advertisement for a special deal of 20% off to the advertisement server and specifies the date as before Valentine's Day, the time as morning, and the target group as male. If a potential customer matches these requirements, the advertisement is pushed to the customer's voice terminal. If the potential customer wishes to buy flowers and he does not know exactly what he is looking for, the customer can push the “push-to-call” button to talk to the merchant. When the merchant receives the call, the merchant is made aware that the source of the advertisement is from a special deal 20% off advertisement. If the potential customer wants to know what flower styles he may order, the merchant can send pictures from the merchant voice terminal to the potential customer voice terminal. If the potential customer likes an available style, the customer can place an order for that style. The merchant then requests billing information from the customer. If the customer agrees to pay, he can enter a password for sending billing information securely. In another example, without limitation, a housewife would like to cook a dinner with certain ingredient. She may do the search from the device and display a recipe based on her requirement. If she has question regarding the way how to cook. She may push “talk” button and talk with the information provider.

FIG. 2 illustrates a block diagram of an exemplary system enabling a merchant to submit an advertisement to an advertisement server 202, in accordance with an embodiment of the present invention. The merchant subscribes advertisement services via advertisement server 202 through a connection 203 with merchant information. Those skilled in the art, in light of the present teachings, will readily recognize that a multiplicity of suitable types of connections may be used for connection 203 including, without limitation, the Internet, a wireless network connection, a phone network connection, a local area network connection, etc. Based on the merchant requested service, for example, without limitation, advertisement or information server 202 provides the merchant with a merchant ID that links with a communication ID such as, but not limited to, a phone number, a random number, etc. The communication ID with product information is used for voice, text or image exchange between the merchant and a potential customer through a call management server.

To place an advertisement or information on advertisement or information server 202, the merchant or service provider uses a computer system 201 to log onto and provide an advertisement or information to advertisement or information server 202. In the present embodiment, the merchant provides an advertisement in digital image format to advertisement server 202 and may include additional information such as, but not limited to the date-to-post, the time-to-post, the location-to-post, the advertisement title, and the target group. All of the information is then stored in an advertisement server database within advertisement server 202, and advertisement server 202 generates an advertisement ID for the merchant. In alternate embodiments the merchant may submit an advertisement to the advertisement server in a non-digital format. For example, without limitation, the merchant may mail or fax a hard copy of the advertisement to an administrator of the advertisement server who turns the hard copy into a digital format to place on the advertisement server.

FIG. 3 is a flow chart illustrating an exemplary process for push advertisement to a voice terminal, in accordance with an embodiment of the present invention. In step 301 a customer voice terminal connects with an advertisement/information server and submits customer information such as, but not limited to, local time, location, customer data, preferences, etc. After step 301 in step 302, the advertisement sever analyzes the customer information received from the customer voice terminal to look for matched advertisements/information within an advertisement/information server database. Also in step 302, if there is a matched advertisement/information, the advertisement/information server pushes the advertisement/information to the customer voice terminal with information including, without limitation, the merchant information and the advertisement/information ID. Then the customer voice terminal displays the advertisement with a “push-to-call” or a “buy-it-now” option on the display in step 303. Alternate embodiments may include additional options with the advertisement for example, without limitation, an option to see if the merchant has the particular product in stock, an option to see directions to the merchant's business location, or alternative product etc. This process is performed periodically if an advertisement feature is enabled on the customer voice terminal.

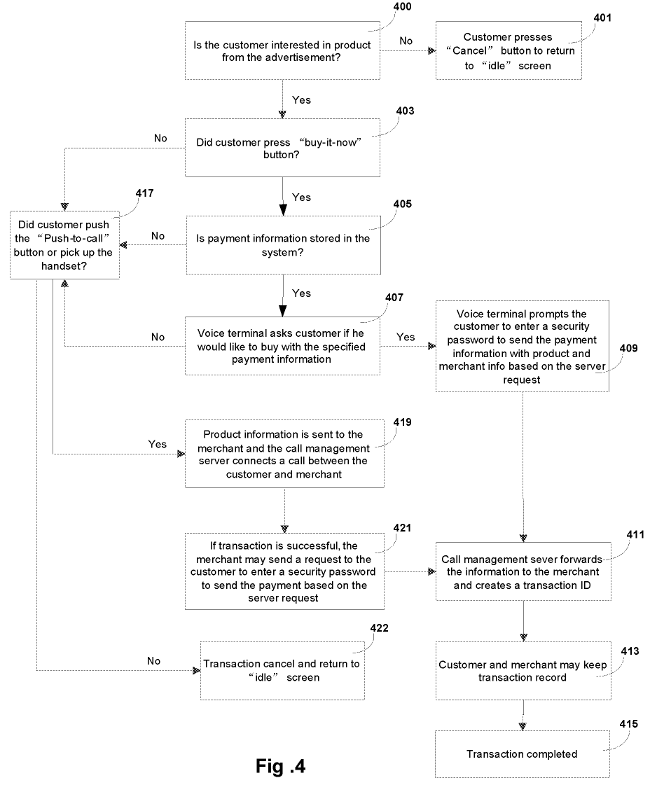

FIG. 4 is a flow chart illustrating an exemplary process for a potential customer to interact with a customer voice terminal to make a transaction with a merchant using “push-to-call” and “buy-it-now” options, in accordance with an embodiment of the present invention. In step 400 the customer determines if he is interested in the product from an advertisement displayed on the customer voice terminal. If the customer is not interested in the advertisement, he may press a “cancel” button on the customer voice terminal to return to an idle screen in step 401. If the potential customer is interested in the advertisement in step 400, the customer may press a “buy-it-now” button on the customer voice terminal in step 403. If the customer presses the “buy-it-now” button, the customer voice terminal then determines whether payment information for the customer is stored in the system in step 405. If the payment information is stored in the system, the customer voice terminal asks the customer if he wants to buy the product now using the specified payment information in step 407. If the customer indicates to the voice terminal that he would like to buy the product now, the customer voice terminal prompts the customer to enter a security password for sending the payment information with additional information, for example, without limitation, an email address for the customer, the advertisement ID, and the merchant ID based on a server request in step 409. A call management sever forwards all of the information to a merchant computer system and generates a transaction ID for both the customer and the merchant and sends them each a record in step 411. The customer and the merchant are able to keep track their transaction records in step 413. The transaction is then completed in step 415.

If the customer does not push the “buy-it-now” button in step 403, the payment information is not stored in the system in step 405 or if the customer does not want to push to buy the product with the specified customer information in step 407, the customer may pick up a handset on the voice terminal or push a “push-to-call” button to talk with the merchant via the call management server in step 417. If the customer does not pick up the handset or select the “push-to-call” button, the transaction is cancelled in step 422. If the customer picks up the handset or selects the “push-to-call” button, product information is sent to the merchant to inform the merchant of the product in which the customer is interested, and the call management server connects the customer and merchant in step 419. If the transaction is successful, the merchant may send a request to the customer via the call management server for entering a security password to send payment information with additional information such as, but not limited to, an email address for the customer, the advertisement ID and the merchant ID based on a server request in step 421. The call management server then forwards all of the information to the merchant computer system, and generates a transaction ID for both the customer and the merchant and sends them a record in step 411. The customer and the merchant are able to keep track their transaction record in step 413, and the transaction is completed in step 415.

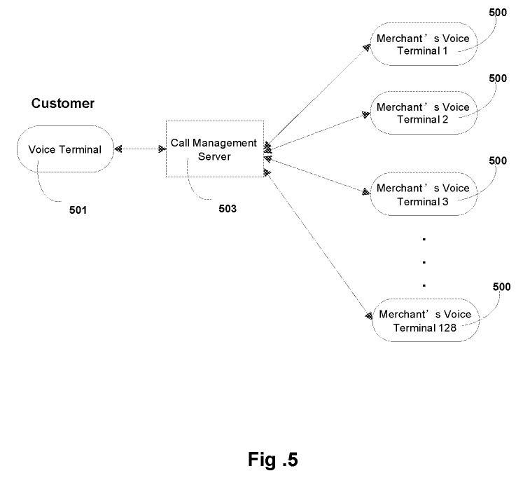

FIG. 5 is a block diagram illustrating an exemplary system enabling a merchant to manage multiple potential customers by setting up multiple merchant voice terminals 500, in accordance with an embodiment of the present invention. In the present embodiment, the merchant can set up the multiple voice terminals 500 through a call management server 503 in order to answer multiple customer inquiries from a customer voice terminal 501. One customer voice terminal 501 is connected to call management server 503 in the present embodiment; however, in alternate embodiments multiple customer voice terminals may be connected to the call management server.

Alternative embodiments of the present invention may be implemented for purposes other than buying and selling products and services. For example, without limitation, some embodiments may be implemented to conduct a survey or to distribute political advertisements. Other alternate embodiments may be used to provide news or weather alerts to a user. Yet other alternate embodiments may be used to deliver public service announcements.

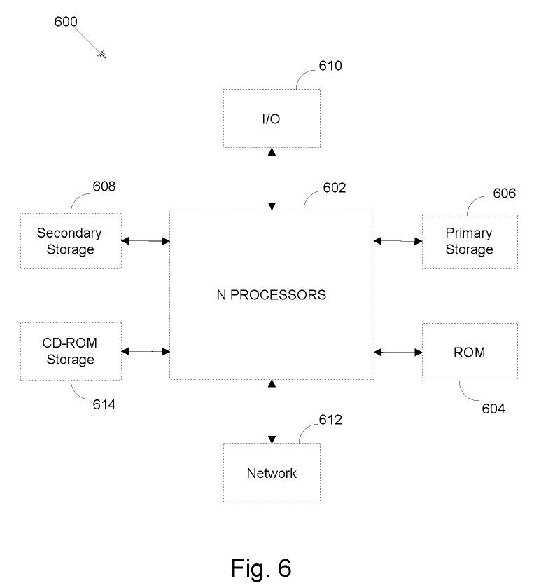

FIG. 6 illustrates a typical computer system that, when appropriately configured or designed, can serve as a computer system in which the invention may be embodied. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection as shown generally at 612, which may be implemented as a hardwired or wireless communications link using suitable conventional technologies. With such a connection, it is contemplated that the CPU might receive information from the network, or might output information to the network in the course of performing the method steps described in the teachings of the present invention.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112 (6) it is intended that the corresponding means for and/or steps for carrying out the claimed function also include those embodiments, and equivalents, as contemplated above that implement at least some novel aspects and objects of the present invention in the jurisdiction of the USA. For example, without limitation, the advertisement server, the information server, call management server, voice terminals and their functions may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of providing an advertisement method for devices on a mobile network according to the present invention will be apparent to those skilled in the art. The invention has been described above by way of illustration, and the specific embodiments disclosed are not intended to limit the invention to the particular forms disclosed. For example, the particular implementation of the advertisement/information server and call management server may vary depending upon the particular type of servers used. The servers described in the foregoing were directed to separate implementations; however, similar techniques are to provide an advertisement and call management server integrated into a single server. Implementations of the present invention with combined components are contemplated as within the scope of the present invention. The invention is thus to cover all modifications, equivalents, and alternatives falling within the spirit and scope of the following claims.

What is claimed is:

1. A method for pushing information to and receiving information from a voice terminal over a communication network, the method comprising the steps of:
a client in possession of the voice terminal storing at least one piece of personal information in the voice terminal;
said client enabling an advertisement feature of the voice terminal;
the voice terminal communicating with an information server in response to said enabling and transmitting to said information server said at least one piece of personal information;
the voice terminal receiving from said information server an information item provided by an information provider wherein content of said information item at least in part matches said at least one piece of personal information;
said client viewing said information item;
if said client desires additional information on said information item, said client activating a first feature of the voice terminal wherein the voice terminal connects to an information provider voice terminal such that said client can request and receive said additional information from said information provider; and
if said client chooses to respond to a request contained in said information item, said client activating a second feature of the voice terminal wherein the voice terminal connects to a system of said information provider for transmission of a response from said client to said information provider.

2. The method as recited in claim 1, wherein the voice terminal connects to said information provider through a call management server.

3. The method as recited in claim 2, wherein the voice terminal communicates with said information server periodically when said advertisement feature is enabled.

4. The method as recited in claim 3, wherein when the voice terminal connects to said information provider, the voice terminal transmits at least one identifying item identifying said information item.

5. The method as recited in claim 4, wherein said information provider is a merchant, said information item is an advertisement/information for a product and said client is a potential customer.

6. The method as recited in claim 5, wherein when the voice terminal receives said advertisement, the voice terminal further receives a merchant ID for identifying the merchant, an advertisement/information ID for identifying said product during communication from said advertisement/information server and a communication ID with product information used to establish said communication from said customer to said merchant.

7. The method as recited in claim 6, wherein said response from said potential customer is a request to buy said product.

8. The method as recited in claim 7, wherein when said potential customer completes a transaction with said merchant, said potential customer receives a transaction ID from said call management server.

9. A system for an information provider to push an information item to a client and receive information from the client over a communication network, the system comprising:
a voice terminal in possession of the client;
at least one piece of personal information about the client stored in said voice terminal;
an advertisement feature of said voice terminal selectively enabled by the client;
an information server in communication with said voice terminal wherein in response to said advertisement feature being enabled said voice terminal transmits to said information server said at least one piece of personal information and said information server transmits the information item to said voice terminal when content of the information item at least in part matches said at least one piece of personal information;
a first feature of the voice terminal selectable by the client when the client desires additional information on the information item;
an information provider voice terminal of the information provider in communication with said voice terminal when the client activates said first feature wherein the client can communicate with the information provider;
a second feature of said voice terminal selectable by the client when the client desires to respond to a request contained within the information item; and
a computing system of the information provider in communication with said voice terminal when the client activates said second feature wherein said voice terminal transmits a response from the client to the information provider.

10. The system as recited in claim 9, further comprising a call management server connecting said voice terminal to the information provider.

11. The system as recited in claim 10, wherein when said advertisement feature is enabled, said voice terminal periodically communicates with said information server.

12. The system as recited in claim 11, further comprising at least one identifying item identifying the information item wherein when said voice terminal connects to the information provider, said voice terminal transmits said at least one identifying item.

13. The system as recited in claim 12, wherein the information provider is a merchant, the information item is an advertisement for a product, the client is a potential customer and the system further comprises a merchant ID for identifying the merchant, said at least one identifying item is an advertisement/information ID for identifying the product during communication from the advertisement/information server and a communication ID with product information used to establish said communication from the customer to the merchant.

14. The system as recited in claim 13, wherein said response from the potential customer is a request to buy the product.

15. The system as recited in claim 14, further comprising a transaction ID transmitted from said call management server to the potential customer and the merchant when the potential customer completes a transaction with the merchant.

16. A computer program product for pushing information to and receiving information from a voice terminal over a communication network, the computer program product comprising:
computer code for a client in possession of the voice terminal storing at least one piece of personal information in the voice terminal;
computer code for said client enabling an advertisement feature of the voice terminal;
computer code for the voice terminal periodically communicating with an information server in response to said enabling and transmitting to said information server said at least one piece of personal information;
computer code for the voice terminal receiving from said information server an information item provided by an information provider wherein content of said information item at least in part matches said at least one piece of personal information;
computer code for said client viewing said information item;
computer code for if said client desires additional information on said information item, said client activating a first feature of the voice terminal wherein the voice terminal connects to an information provider voice terminal such that said client can request and receive said additional information from said information provider;
computer code for if said client chooses to respond to a request contained in said information item, said client activating a second feature of the voice terminal wherein the voice terminal connects to a system of said information provider for transmission of a response from said client to said information provider; and
a computer readable medium for storing the computer code.

17. The computer program product as recited in claim 16, wherein the voice terminal connects to said information provider through a call management server.

18. The computer program product as recited in claim 17, wherein said information provider is a merchant, said information item is an advertisement for a product, said client is a potential customer and when the voice terminal receives said advertisement, the voice terminal further receives a merchant ID for identifying the merchant, an advertisement/information ID for identifying said product during communication from said advertisement/information server and a communication ID with product information used to establish the communication from said customer to said merchant.

19. The computer program product as recited in claim 18, wherein said response from said potential customer is a request to buy said product.

20. The computer program product as recited in claim 19, wherein when said potential customer completes a transaction with said merchant, said potential customer receives a transaction ID from said call management server.
